(19) United States
(12) Patent Application Publication
(10) Pub. No.: US 2023/0286781 A1
(43) Pub. Date: Sep. 14, 2023

(54) Method for relative positioning of a spreader

(71) Applicant: Cargotec Finland Oy, Tampere (FI)

(72) Inventors: Wenyan Yang, Tampere (FI); Mohammad Aref, Tampere (FI); Juho Vihonen, Kangasala (FI); Jyri Lukkala, Tampere (FI); Mikko Asikainen, Kangasala (FI); Hannu Santahuhta, Orivesi (FI)

(21) Appl. No.: 18/009,747

(22) PCT Filed: Jul. 2, 2021
(86) PCT No.: PCT/FI2021/050517

§ 371 Date: Dec. 12, 2022

(30) Foreign Application Priority Data
Jul. 6, 2020 (FI) 20205729

(51) Int. Cl. B66C 13/46; G06V 10/44; B66C 19/00

(52) U.S. Cl. CPC B66C 13/46; G06V 10/44; B66C 19/007; G06V 2201/07

(57) ABSTRACT

There is provided an apparatus comprising means for: receiving a first image of a first feature of a load; receiving a second image of a second feature of the load; determining image plane coordinates of the features of the load based on the first image and the second image; determining one or more action candidates based on the image plane coordinates; evaluating the one or more action candidates using an intermediate medium embodying historical experience information within a finite time horizon; choosing a control action based on the evaluation, wherein the control action causes a spreader to move with respect to the load.

### FIELD

Various example embodiments relate to positioning of a spreader.

### BACKGROUND

Heavy load transportation industries involve handling heavy loads, e.g. when loading and unloading vehicles e.g. in harbours and on ships. For example, in container logistics, a spreader is used in crane systems for lifting a container. Spreaders are often controlled by a trained human operator who requires extensive training to become familiar with the spreader control system. This kind of spreader control system is prone to human errors.

### SUMMARY

According to some aspects, there is provided the subject-matter of the independent claims. Some example embodiments are defined in the dependent claims. The scope of protection sought for various example embodiments is set out by the independent claims. The example embodiments and features, if any, described in this specification that do not fall under the scope of the independent claims are to be interpreted as examples useful for understanding various example embodiments.

According to a first aspect, there is provided an apparatus comprising means for: receiving a first image of a first feature of a load; receiving a second image of a second feature of the load; determining image plane coordinates of the features of the load based on the first image and the second image; determining one or more action candidates based on the image plane coordinates; evaluating the one or more action candidates using an intermediate medium embodying historical experience information within a finite time horizon; choosing a control action based on the evaluation, wherein the control action causes a spreader to move with respect to the load.

According to an embodiment, the apparatus comprises means for determining a pairwise operation between the image plane coordinates of the first feature and the image plane coordinates of the second feature; determining the one or more action candidates based on the pairwise operation; determining the control action based on costs and/or rewards based on the action candidates.

According to an embodiment, the reward achieves its highest value when the spreader substantially aligns with the load or achieves substantial alignment in the finite time horizon in the future.

According to an embodiment, the cost is proportional to force or energy or pressure or voltage or current or placement or placement consumption based on the action candidates and their effect in the spreader motion at the current moment or in the finite time horizon in the future; and/or reflects risk of losing features in a camera's field of view at the current moment or in the finite time horizon in the future.

According to an embodiment, the apparatus comprises means for transmitting the control action directly or indirectly to one or more actuators for moving the spreader with respect to the load.

According to an embodiment, the first image is received from a first camera located on a first corner of a spreader and the second image is received from a second camera located on a second corner of the spreader, wherein the first corner and the second corner are different corners, and wherein the first feature of the load is a first corner of a container and the second feature of the load is a second corner of the container, wherein the first corner of the spreader and the first corner of the container are corresponding corners and the second corner of the spreader and the second corner of the container are corresponding corners.

According to an embodiment, the means comprises at least one processor; and at least one memory including computer program code, the at least one memory and the computer program code configured to, with the at least one processor, cause the performance of the apparatus.

According to a second aspect, there is provided a method comprising: receiving a first image of a first feature of a load; receiving a second image of a second feature of the load; determining image plane coordinates of the features of the load based on the first image and the second image; determining one or more action candidates based on the image plane coordinates; evaluating the one or more action candidates using an intermediate medium embodying historical experience information within a finite time horizon; choosing a control action based on the evaluation, wherein the control action causes a spreader to move with respect to the load.

According to an embodiment, the method comprises determining a pairwise operation between the image plane coordinates of the first feature and the image plane coordinates of the second feature; determining the one or more action candidates based on the pairwise operation; determining the control action based on costs and/or rewards based on the action candidates.

According to an embodiment, the reward achieves its highest value when the spreader substantially aligns with the load or achieves substantial alignment in the finite time horizon in the future.

According to an embodiment, the cost is proportional to force or energy or pressure or voltage or current or placement or placement consumption based on the action candidates and their effect in the spreader motion at the current moment or in the finite time horizon in the future; and/or reflects risk of losing features in a camera's field of view at the current moment or in the finite time horizon in the future.

According to an embodiment, the method comprises transmitting the control action directly or indirectly to one or more actuators for moving the spreader with respect to the load.

According to an embodiment, the first image is received from a first camera located on a first corner of a spreader and the second image is received from a second camera located on a second corner of the spreader, wherein the first corner and the second corner are different corners, and wherein the first feature of the load is a first corner of a container and the second feature of the load is a second corner of the container, wherein the first corner of the spreader and the first corner of the container are corresponding corners and the second corner of the spreader and the second corner of the container are corresponding corners.

According to a third aspect, there is provided a computer readable medium comprising program instructions that, when executed by at least one processor, cause an apparatus to perform at least: receiving a first image of a first feature of a load; receiving a second image of a second feature of the load; determining image plane coordinates of the features of the load based on the first image and the second image; determining one or more action candidates based on the image plane coordinates; evaluating the one or more action candidates using an intermediate medium embodying historical experience information within a finite time horizon; choosing a control action based on the evaluation, wherein the control action causes a spreader to move with respect to the load.

According to further embodiments, the computer readable medium comprises program instruction that, when executed by at least one processor, cause an apparatus to perform at least the method of any of the embodiments of the second aspect.

According to a further aspect, there is provided a computer program configured to cause a method in accordance with the second aspect and any of the embodiments of the second aspect to be performed.

### BRIEF DESCRIPTION OF THE DRAWINGS

FIG. 1 shows, by way of example, a spreader alignment task;

FIG. 2 shows, by way of example, motion control action visualization;

FIG. 3 shows, by way of example, a flowchart of a method for spreader alignment;

FIG. 4 shows, by way of example, a spreader and a container and image plane based states design;

FIG. 5 shows, by way of example, image plane based states design;

FIG. 6 shows, by way of example, a system architecture;

FIG. 7 shows, by way of example, a block diagram of an apparatus;

FIG. 8 shows, by way of example, a plot of error measurements of alignment trials;

FIG. 9 shows, by way of example, a plot of error measurements of alignment trials;

FIG. 10 shows, by way of example, a plot of error measurements of alignment trials;

### DETAILED DESCRIPTION

Load handling arrangements are used e.g. in ports, terminals, ships, distribution centres and various industries. The following examples are described in the context of crane systems, but the method disclosed herein may be used in any environment where loads are lifted and there is a need for accurate positioning of a spreader used for handling a load, e.g. a container. Handling of the load comprises e.g. lifting, moving, and placement of the load. The crane systems may be considered as any system or equipment with a spreader.

In container logistics, a spreader is used in crane systems for lifting a container. The spreader has a twist locking mechanism at each corner which is accurately positioned to the corner castings of container. In order to lift the container, the spreader needs to be aligned with the container. The process of lifting the container may be, for example, divided into three phases: search phase, alignment phase, landing phase.

In the search phase, the spreader may be moved above the container, to a so called clearance region. A rough estimate of the container's position may be received e.g. from a terminal operating system. Moving the spreader above the container may be performed by using motion commands.

In the alignment phase, the spreader's position, e.g. orientation and/or translation, may be fine-tuned with respect to the container's position or a place available for container placement. This fine-tuning movement may be performed by using motion control commands to run the actuators that are capable of running the commands.

In the landing phase, the spreader may be landed to a desired position determined in the alignment phase. If the spreader's twist locks fit in and lock to the corner castings of the container, the container can be lifted.

There is provided a controller for the alignment phase so that the spreader's position is adjusted so that it will land on the load, e.g. a container, with high precision.

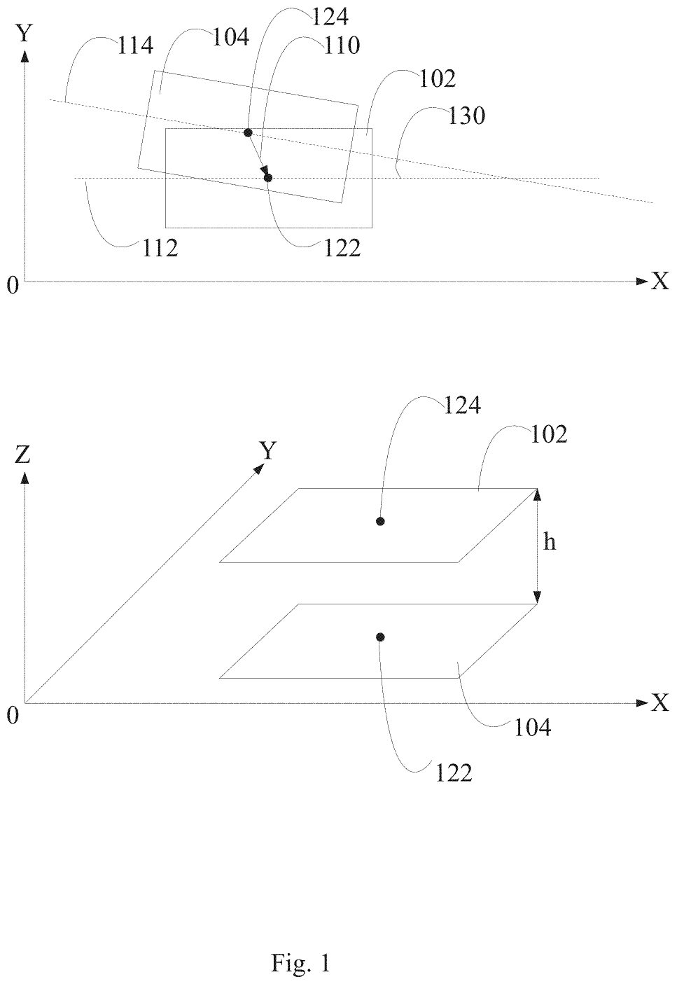

FIG. 1 shows, by way of example, a spreader alignment task. Upper figure of FIG. 1 shows a top view of a situation, wherein a spreader 102 is not aligned with a container 104. The x-axis and the y-axis are the axes of an imaginary common coordinate frame where the spreader 102 and the container 104 may be represented.

The center offset 110 V_{centre}^{→} on the x-y plane between the spreader 102 and the container 104 is (dₓ, d_{y}). The height between the spreader 102 and the container 104 is h. The line 112 has been drawn through a center point 122 of the spreader 102. The line 114 has been drawn through a center point 124 of the container 104. An angle 130 between the lines 112 and 114 is γ representing the skew angle between spreader and container. In this spreader alignment phase, the goal of the policy generated by controller is to minimize V_{centre}^{→} and γ, so that V_{centre}^{→}=(0,0) and γ=0.

Lower figure of FIG. 1 shows a view in x-y-z coordinate system, wherein the spreader is aligned with the container. For example, the center points of the spreader and the container, i.e. the point 124 and the point 122, are aligned such that V_{centre}^{→}=(0,0) and γ=0.

The controller may be represented as:

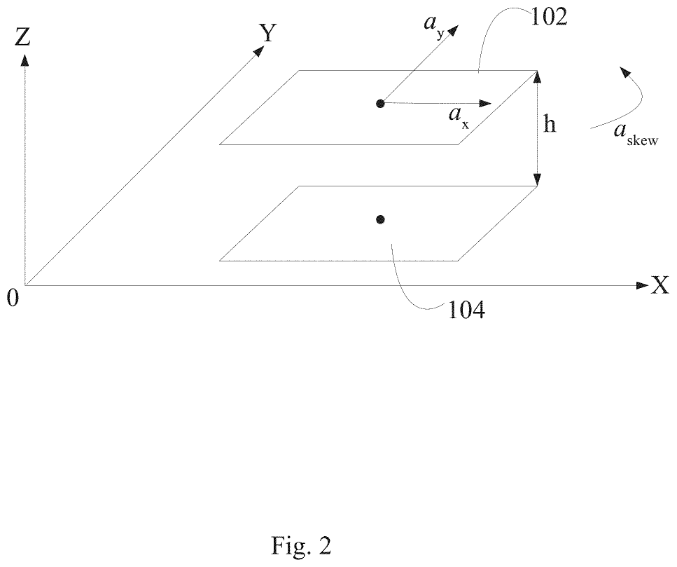

a=π(s)

where a=[aₓ, a_{y}, a_{skew}] is a three dimensional vector representing the motion control actions (as is shown in FIG. 2), s is spreader observed state representation, and π represents the control policy. The observed state may be computed on the spreader coordinates and container coordinates expressed in a common coordinate system or image coordinate system. The common coordinate based state is used when the coordinates are obtained from the sensors, i.e. the coordinates of the container and the spreader in the common coordinate system are accurately measured. Below, the state design based on image coordinate system is described.

FIG. 2 shows, by way of example, motion control action visualization. Action aₓ represents movement of the spreader along x-axis, action a_{y} represents movement of the spreader along y-axis, and action a_{skew} represents rotating movement of the spreader on the x-y plane.

There is provided a method for spreader alignment. The method enables choosing the motion control action(s) so that spreader alignment with high accuracy is achieved.

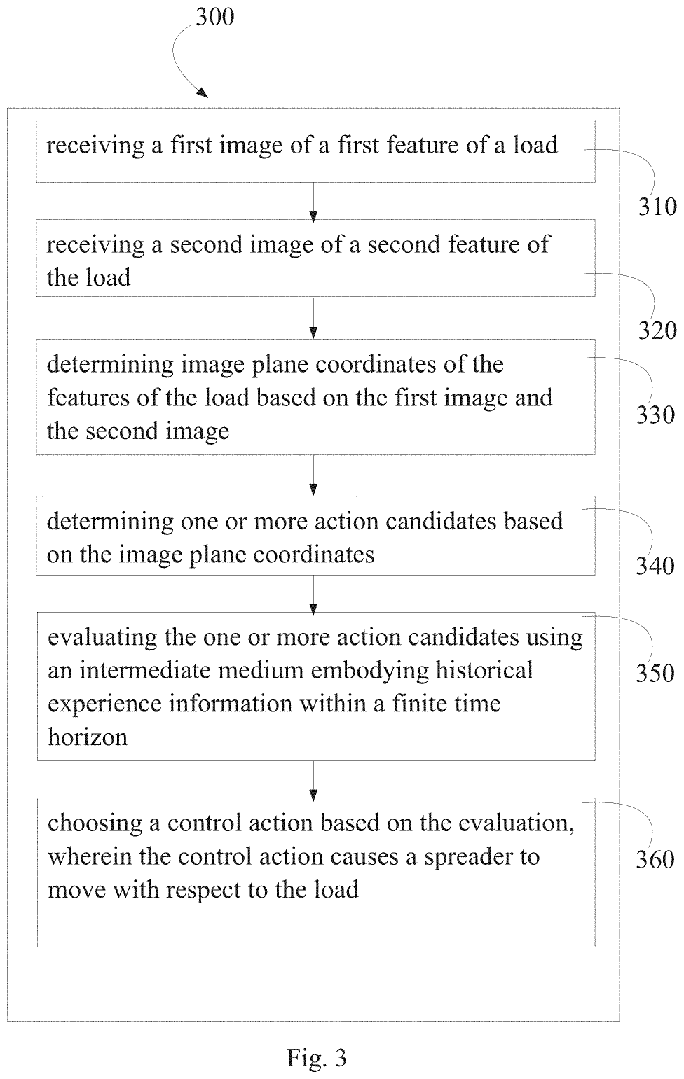

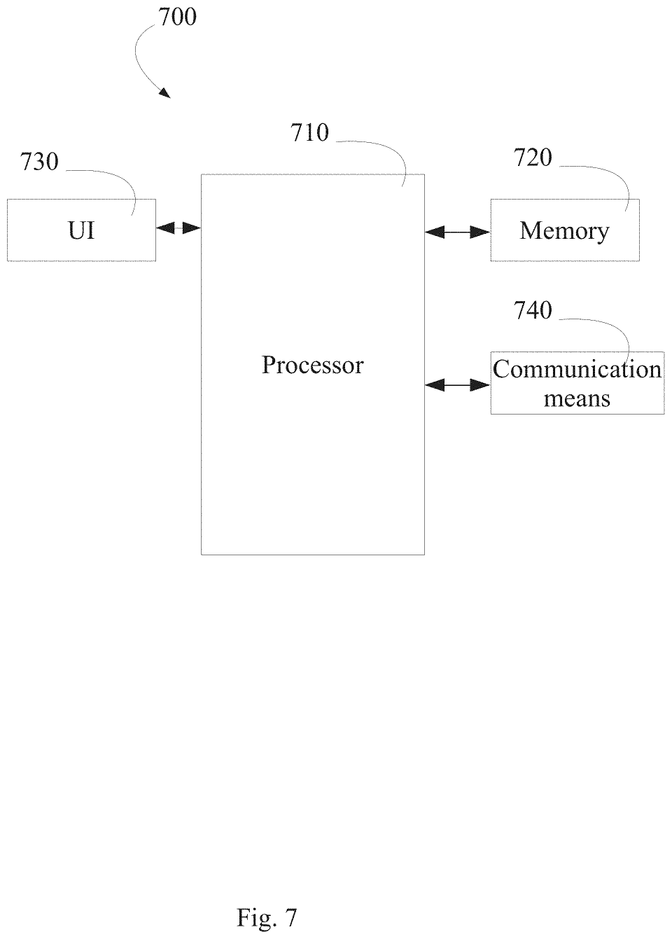

FIG. 3 shows, by way of example, a flowchart of a method for spreader alignment. The method may be performed e.g. by the apparatus of FIG. 7. The method 300 comprises receiving 310 a first image of a first feature of a load. The method 300 comprises receiving 320 a second image of a second feature of the load. The method 300 comprises determining 330 image plane coordinates of the features of the load based on the first image and the second image. The method 300 comprises determining 340 one or more action candidates based on the image plane coordinates. The method 300 comprises evaluating 350 the one or more action candidates using an intermediate medium embodying historical experience information within a finite time horizon. The method 300 comprises choosing 360 a control action based on the evaluation, wherein the control action causes a spreader to move with respect to the load.

The method disclosed herein provides determination of control actions based on image information from spreader sensors, e.g. based on spreader camera stream(s). Other sensor information is not necessarily needed. However, various sensor data may be used, e.g. to create the images, as will be described below. The method disclosed herein enables accurate positioning of the spreader for lifting a load, e.g. a container, without human operation. The method is robust to changes in the cameras and their mutual alignment and singularities in the view of aligned cameras. Moreover, this method relies on a multi-point evaluation of images, which may significantly increase sensitivity to measurement noise and accuracy of prior information, when compared e.g. to using single-point evaluation. The method is independent of time and based on the system geometry. Time independent geometrical operations make the system well applicable to variable latency control. This is beneficial when compared to e.g. pure trajectory control, which enforces high synchronous actuator control and is time critical.

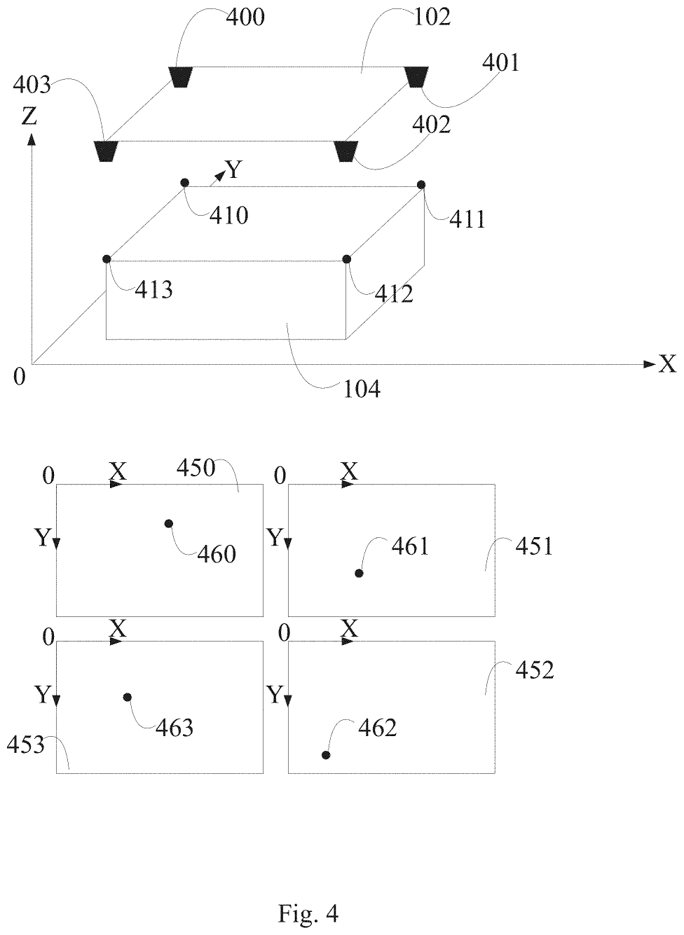

FIG. 4 shows, by way of example, a spreader 102 and a container 104 and image plane based states design. Cameras 400, 401, 402, 403 are attached to the spreader. For example, cameras may be located on corners of the spreader, e.g. one camera on each four corners of the spreader. However, the location of the camera does not need to be exactly on the corner, but approximately on the corner. The choice of number of cameras and their viewpoints may be dependent on the field of view and container visibility. The location and orientation of the cameras may be such that they are directed downwards in order to capture the space below the spreader. Locations of the cameras are known in common coordinates.

For example two cameras, e.g. a first camera and a second camera, may be attached to the spreader. If two cameras are used, the cameras may be wide-angle cameras. The first camera and the second camera are attached to different corners of the spreader. For example, the first camera may be located on a first corner of a spreader, and a second camera may be located on a second corner of the spreader. The first corner and the second corner are different corners. The first corner may be opposite to the second corner such that the first corner and the second corner may be connected with a diagonal line passing through the center point of the spreader. Alternatively, the first corner and the second corner may be adjacent corners.

As a further example, a bird eye camera may be used.

Cameras may be video cameras. Cameras comprise digital image sensor(s), e.g. charge-coupled device (CCD) and/or active-pixel sensor(s), e.g. complementary metal-oxide-semiconductor (CMOS) sensor(s). Images are received from one or more cameras. For example, a first image may be received from the first camera, and a second image may be received from the second camera. Alternatively, images may be received from three or four cameras, or from a bird-eye camera. In case of the bird-eye camera, the first image and the second image are e.g. cropped from a wider image. The first image comprises, or shows, an image of a first feature of the container. The first feature may be a first corner of the container. Alternatively, the first feature may be a twist-lock hole, a marking, a landmark or any feature that may be detected from the image and which may be associated to the first corner of the container. In some cases, features which may geometrically define a rectangle may be an alternative for the corners. The first corner of the container corresponds to the first corner of the spreader. Corresponds here means, for example, that the camera 400 tries to capture a corner 410, or some other feature, of the container. For example, the corner 410 corresponds to the corner where the camera 400 is located; the corner 411 corresponds to the corner where the camera 401 is located; the corner 412 corresponds to the corner where the camera 402 is located; the corner 413 corresponds to the corner where camera 403 is located.

Instead of receiving the images from the camera(s), the images may be received from a memory, where they have been stored. In some cases, images comprising the features, e.g. the corners, may be created based on range sensor data, or distance sensor data. For example, time-of-flight cameras or lidars may be used to feature detection, e.g. corner detection.

The second image comprises, or shows, an image of a second feature of the container. The second feature may be a second corner of the container. Alternatively, the second feature may be a twist-lock hole, a marking, a landmark, or any feature that may be detected from the image and which may be associated to the second corner of the container. The second corner of the container corresponds to the second corner of the spreader. The features, e.g. corners, may be detected from the images via image processing techniques for object detection. Denote the corner detection function as F. For example, the corners may be detected using edge detection methods, e.g. edge approaching (EA) detection methods, and hue, saturation, value (HSV) algorithm. The HSV algorithm may filter and segment the container based on color and the EA method may calculate the container's rotation angle. Neural network(s) (NN(s)) provide a robust approach for object detection. For example, deep learning may be used to conduct feature extraction, e.g. corner casting detection. The received images streamed from the cameras may be fed into neural network to detect the features, e.g. container's corners. The NN may be composed of e.g. two modules: convolutional neural network (CNN) part and long-short-term-memory (LSTM) module. The received images may be combined and sent to the CNN to extract high-level features while LSTM may recurrently predict the corners of the container.

Image plane coordinates of the features of the container may be determined based on the received images. For example, the image plane coordinates of the corners of the container may be determined based on the first image and the second image. The image plane based states are based on the container's corners projected from common coordinate system to the image planes. By determining or measuring the feature locations in the image plane, measurement errors related to physical coordinate measurements by sensors are avoided. Use of physical coordinate measurements makes system sensitive to any changes in configuration and it requires very accurate knowledge in dimensions of the system. In addition, there is no need for camera calibration such as in model-based approaches, wherein a small error in camera's extrinsic and/or intrinsic parameters estimation may end up with large physical estimation error which is proportional to camera's focal length and spreader's size. When a plurality of cameras are used in model-based approaches, the error accumulates. As disclosed herein, the mapping from image coordinates, not the physical coordinates, to target pose is directly found, need for the camera calibration is avoided.

In this example, let us consider four image planes 450, 451, 452, 453. There may be four cameras 400, 401, 402, 403 located on the spreader's corners. The cameras 400, 401, 402, 403 may be denoted as cam₀, cam₁, cam₂, cam₃, respectively. The image 450 may be received from the camera 400, the image 451 may be received from the camera 401, the image 452 may be received from the camera 402, and the image 453 may be received from the camera 403. Let us denote four corners 410, 411, 412, 413 of the container in common coordinate system as points p_{c0}, p_{c1}, p_{c2} and p_{c3}, respectively. Let us denote the corners (or other features) 460, 461, 462, 463 of the container on the projected camera image planes 450, 451, 452, 453 as points p₀, p₁, p₂ and p₃, respectively.

Let us introduce the notation Xⱼ for the world point represented by the homogenous 4-vector (x_{offsetc}, y_{offfset}, z_{offset}, 1) on the relative coordinates. Let us denote camera's position in common coordinate system as p_{cam}=(x_{cam}_{ⱼ}, y_{cam}_{ⱼ}, z_{cam}_{ⱼ}) and container's corner position in common coordinate system as p_{c}=(x_{c}_{ⱼ},y_{c}_{ⱼ},z_{c}_{ⱼ}). Then:

Xⱼ=(x_{c}_{ⱼ}−x_{cam}_{ⱼ},y_{c}_{ⱼ}−y_{cam}_{ⱼ},z_{c}_{ⱼ}−z_{cam}_{ⱼ},1)=(x_{offsetc},y_{offset},z_{offset},1)

For each corner p_{j,j=0,1,2,3} on each image plane, its projection is based on the projection equation:

pⱼ=PXⱼ^{T}

where P is the projection matrix:

P=K[R|T]

R and T are the camera's extrinsic parameters, which relate the image frame's orientation and position to the common coordinate system. K is the finite projective camera's intrinsic parameter matrix:

$$K = [ \begin{matrix}{α}_{x} & s & {x}_{0} \\ 0 & {α}_{y} & {y}_{0} \\ 0 & 0 & 1\end{matrix} ]$$

If the number of pixels per unit distance in image coordinates are mₓ and m_{y} in the x and y directions, and the focal length is denoted as f, then it applies that

aₓ=f·mₓ,a_{y}=f·m_{y},

wherein aₓ and a_{y} represent the focal length of the camera in terms of pixel dimensions in the x and y direction respectively. Parameter s is referred to as the skew parameter. The skew parameter will be zero for most normal cameras.

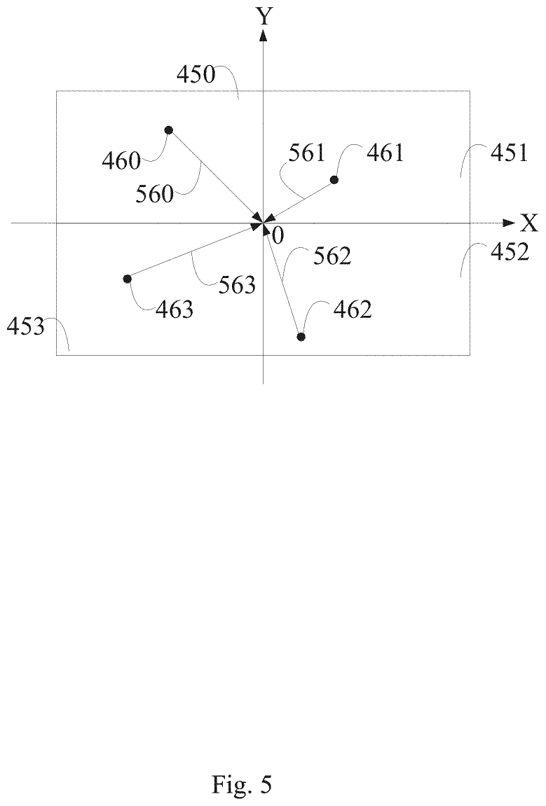

FIG. 5 shows, by way of example, image plane based states design. The states may be defined on a new cartesian coordinate system which is combined of the four image planes. The vector 560 from p₀ 460 to the origo 0 is Vₚ_{₀}ₒ^{→}. The vector 561 from p₁ 461 to origo is Vₚ_{₁}ₒ^{→}. The vector 562 from p₂ 462 to origo is Vₚ_{₂}ₒ^{→}. The vector 563 from p₃ 463 to origo is Vₚ_{₃}ₒ^{→}.

An angle between the vectors 560 and 562 may be defined as

θ=angle(Vₚ_{₀}ₒ^{→},Vₚ_{₂}ₒ^{→}),θ∈[−π,π].

An angle between the vectors 561 and 563 may be defined as

α=angle(Vₚ_{₁}ₒ^{→},Vₚ_{₃}ₒ^{→}),αΣ[−π,π].

Further, it may be defined that θ′=π−θ,θ′∈[−π,π] and α′=π−α,α′∈[—π,π].

The states may be defined by four vectors and two angles between the vectors. The states may be defined as follows:

state=[Vₚ_{₀}ₒ^{→},Vₚ_{₁}ₒ^{→},Vₚ_{₂}ₒ^{→},Vₚ_{₃}ₒ^{→},θ′,α′]=[xₚ_{₀}′,yₚ_{₀}′,xₚ_{₁}′,yₚ_{₁}′,xₚ_{₂}′,yₚ_{₂}′,xₚ_{₃}′,yₚ_{₃}′,θ′,α′]

In case of two images, the states may be defined by two vectors and an angle between the two vectors. As another example, the states may be the images themselves.

Another option is to use the symmetric feature for matching the position between the spreader and the container. In other words, a pairwise operation may be determined between the image plane coordinates of the first corner (or feature) and the image plane coordinates of the second corner (feature). The states S_{IPS} may be defined based on image plane symmetric coordinates.

In pairwise operation, images are compared with images, or image features are compared with image features without mapping them into physical distances, e.g. metric distances. This enables minimizing effects of calibration errors, camera miss alignments, and inclined containers or floors on crane operations, for example. As long as cameras are nearly similar to each other, role of camera optics calibration or intrinsic camera parameters is minimal. When using pairwise operation, decisions are made based on the current view and what will happen to the compared pairs in the near future. Thus, the system updates its expectations from the near future based on the differences in the views of the cameras, without relying on past points and their positions in the physical system. Features that are compared with each other may be planar, simple features, such as mathematical point at a corner of a container, without requiring a sense of size or need for prior template view of an object. This simplifies the image processing, since complicated object recognition and/or object pose estimation is/are not needed.

A pairwise operator is an operator which has a monotonic or piecewise monotonic behaviour correlated with either decreasing or increasing errors in alignment of the spreader and the container or the available placement for the container. An example of a pairwise operator is the norm of dot or cross multiplication of error vectors in any pair of camera images. Another example of a pairwise operator is the norm of dot or cross multiplication of feature position vectors in any pair of camera images. In other words, for any chosen pair of camera images, the system compares features on the camera images either with respect to their error or to their position.

Pairwise operation, e.g. pairwise symmetry operation, is beneficial for a learning algorithm such as reinforcement learning (RL) algorithm. By defining the symmetrical or pairwise nature to the artificial intelligence (AI) controller, it is able to learn a usable control policy without any ground truth knowledge from uncalibrated sensors or cameras or from accurate physical coordinate measurements or human expert guidance. A spreader has similar rectangular-like geometry as a container. Therefore, when there is no or minimal offset in x, y, and skew, the change in the views becomes comparable to each other or from one camera to another. The pairwise operation may be generalized to rectangle shaped geometries that exhibit any symmetrical visual properties.

f=Flip(p) represents the symmetric operations, e.g. Flip_{tl→br}(p₀) means flipping point p₀ 460 from top left (tl) to bottom right (br). Top left (tl) refers to image 450, top right (tr) refers to image 451, bottom right (br) refers to image 452, and bottom left (bl) refers to image 453.

p₂−Flip_{tl→br}(p₀)=(dₓ_{_{tl→br}},d_{y}_{_{tl→br}})

p₃−Flip_{tr→bl}(p₁)=(dₓ_{_{tr→bl}},d_{y}_{_{tr→bl}})

p₁−Flip_{tl→br}(p₀)=(dₓ_{_{tl→tr}},d_{y}_{_{tl→tr}})

p₃−Flip_{br→bl}(p₂)=(dₓ_{_{br→bl}},d_{y}_{_{br→bl}})

p₂−Flip_{tr→br}(p₁)=(dₓ_{_{tr→br}},d_{y}_{_{tr→br}})

p₃−Flip_{tl→bl}(p₀)=(dₓ_{_{tl→bl}},d_{y}_{_{tl→bl}})

The symmetric feature may be used to match the position between the spreader and the container. When the spreader is aligned with the container, the corner's coordinates on the image planes have the following features:

p₂−Flip_{tl→br}(p₀)=(x_{offset}_{_{tl→br}},y_{offset}_{_{tl→br}})

p₃−Flip_{tr→bl}(p₁)=(x_{offset}_{_{tr→bl}},y_{offset}_{_{tr→bl}})

p₁−Flip_{tl→br}(p₀)=(x_{offset}_{_{tl→br}},y_{offset}_{_{tl→br}})

p₃−Flip_{br→bl}(p₂)=(x_{offset}_{_{br→bl}},y_{offset}_{_{br→bl}})

p₂−Flip_{tr→br}(p₁)=(x_{offset}_{_{tr→br}},y_{offset}_{_{tr→br}})

p₃−Flip_{tl→bl}(p₀)=(x_{offset}_{_{tl→bl}},y_{offset}_{_{tl→bl}})

so that

target_{symmetric}={x_{offset}_{_{tl→br}},y_{offset}_{_{tl→br}}, . . . ,x_{offset}_{_{tl→bl}},y_{offset}_{_{tl→bl}}}

refers to a target offset when the spreader and container are aligned. The target symmetric can be non-zero depending on the cameras' poses and image plane definitions.

The states in this case may be defined as:

state_{symmetric}=[dₓ_{_{tl→br}},d_{y}_{_{tl→br}}, . . . ,dₓ_{_{tl→bl}},d_{y}_{_{tl→bl}}]

Action candidates, e.g. motion control action candidates, may be determined. The determination may be based on the determined image plane coordinates of the features of the container on the images, e.g. the corner of the container on the first image and the corner of the container on the second image, with respect to each other. The determination may be, alternatively or in addition, based on historical information derived from the images.

Action candidates determine different control commands for moving the spreader. As described above for the controller, the control command may be represented as a vector defining movement to x- and y-directions, and rotation, i.e. skew. The actions or control commands may be determined e.g. via energy, force, power, voltage, current, and/or displacement. For example, the system needs energy to move the spreader, and the energy may be transmitted in the system e.g. via pressure changes, electricity, etc. Actions may be e.g. discrete or continuous. A reinforcement learning (RL) algorithm may be used to learn the spreader-alignment task. Reinforcement learning (RL) is a type of a machine learning technique that enables an agent to learn in an interactive environment using feedback from its own actions and experiences. In RL, in a certain state of the environment, an agent or an optimization algorithm, performs an action according to its policy e.g. a neural network, that changes the environment state and receives a new state and reward for the action. The agent's policy is then updated based on the reward of the state-action pair. RL learns by self-exploration which is or may be conducted without human interference.

For discrete actions, there is a set of action candidates, wherein the actions have a fixed value. For example, the action candidate may be defined as a=[aₓ∈{−1,1}, a_{y}∈{−1,1}, a_{skew}∈{−1,1}], wherein −1 (negative) and 1 (positive) refer to different directions. For example, −1 may refer to a displacement to direction of negative x-axis or y-axis or counterclockwise rotation, and +1 may refer to a displacement to direction of positive x-axis or y-axis or clockwise rotation. A policy in this case may be learned to generate the possibilities of which action should be taken based on the current state. The action may be given as π(a|s), wherein a is the action, s is the state and π is the policy. In at least some embodiments, the action candidates are sample time independent which is beneficial for a system with variable latency. Sample time or cycle time is the rate at which a discrete system samples its inputs or states.

The outcome of the policy indicates probabilities of the different actions, e.g. [a_{x_positive}=0.5, a_{y_positive}=0.35, a_{skew_positive}=0.8, a_{x_negative}=0.35, a_{y_negative}=0.35, a_{skew_negative}=0.18], and one action a_{skew_positive} with the highest probability may be chosen. RL algorithm for discrete actions may be e.g. deep Q-learning network (DQN).

For continuous actions, there is a set of action candidates, wherein the value for the actions is not fixed. For example, the action candidate may be defined as a=[aₓϵ[−1,1], a_{y}ϵ[−1,1], a_{skew}ϵ[−1,1]]. A policy in this case may be a deterministic policy, which is learned to give a specific value for each action. The action may be given as a=π(s).

The outcome of the policy may be e.g. [aₓ=−0.3, a_{y}=0.8, a_{skew}=1], and all the actions may be conducted in one step. RL algorithm for continuous actions may be e.g. deep deterministic policy gradient (DDPG).

Action candidates may be evaluated using an intermediate medium embodying historical experience information within a finite time horizon. For example, the action candidates may be evaluated using the RL algorithm. In RL, the RL agent's goal is to maximize a cumulative reward. In episodic case, this reward may be expressed as a summation of all received reward signals during one episode. The term episode refers to a sequence of actions for positioning the spreader over the container for hoisting down.

Reward may be defined as a mathematical operation based on, e.g., image plane coordinates, or image plane symmetric coordinates.

Common coordinates based state may be used when the coordinates may be obtained from the sensors, i.e. when the coordinates of the container and the spreader in the common coordinate system are accurately measured.

The environment may respond by transitioning to another state and generating a reward signal. The reward signal may be considered to be a ground-truth estimation of agent's performance. The reward signal may be calculated based on the reward function, which may be introduced as stochastic and dependent on action a:

reward (rₜ|sₜ) is the reward function that calculate instantaneous reward rₜ based on current state sₜ at time instant t.

The process continues repeatedly with agent making choices of actions based on observations and environment responding with next states and reward signals. The goal of agent is to maximize the cumulative reward R:

R:=Σₜ₌₁^{T}rₜ is the sum of instant reward rₜ of one trajectory.

The reward function may be designed to guide the RL agent to optimize its policy. For example, the reward function based on a common coordinate frame may be defined as

reward_{common}=−1*∥[V_{centre}^{→},γ]∥₂=−1*∥[dₓ,d_{y},γ]∥₂

As is shown in the reward function, the reward reward_{common} is increasing when spreader is reaching the target position. In the target position it holds that dₓ=0, d_{y}=0, and γ=0. (see FIG. 1). The reward achieves its highest value when the spreader substantially aligns with the load, e.g. when the spreader is perfectly aligned with the load, e.g. the container. Alternatively, the reward achieves its highest value when the spreader achieves substantial alignment in the finite time horizon in the future. This may mean that the alignment is within a pre-defined threshold values. A threshold value may be pre-determined for substantial alignment, or perfect alignment.

The reward based on image coordinates is defined based on the symmetry of the corners, or other pre-determined features, on the received images. The reward may be the L2 norm of the states.

reward_{symmetric}=−1*∥state_{symmetric}−target_{symmetric}∥₂

If the reward is greater than a pre-determined range, then the task is successful.

The primary goal is to maximize the reward. In case of possibility, it may happen together with minimizing a cost. The cost may be proportional to force or energy or pressure or voltage or current or placement or placement consumption based on the action candidates and their effect in the spreader motion at the current moment or in the finite time horizon in the future. The cost may reflect risk of losing features in the camera's field of view at the current moment or in the finite time horizon in the future.

The action candidate that leads to the task being successful may be selected as a control action. The control action causes the spreader to move with respect to the container.

The Deep Deterministic Policy Gradients (DDPG) is an off-policy model-free RL algorithm for continuous control. The actor-critic structure of DDPG makes it utilize the advantages of policy gradient methods (actor) and d value approximation methods (critic). For one trajectory, denote the state s and action a at time step t as sₜ and aₜ. The action-value function approximator, i.e. the critic Q (sₜ, aₜ), represents the expected cumulative return after action aₜ is conducted based on sₜ. Q (sₜ, aₜ) is optimized by minimizing the Bellman error so that

Q(sₜ,aₜ)= [symbol] ᵣ_{ₜ}_{,s}_{ₜ₊₁}_{˜} [symbol] [r(sₜ,aₜ)+γ [symbol] ₐ_{ₜ}[Q(sₜ₊₁,aₜ₊₁)],

where [symbol] is the expectation value of its argument. The action policy part (actor) is a function aₜ=π(sₜ), and is optimized by directly maximizing the estimated actor's action-value function with respect to the parameters of the policy. Concretely, DDPG maintains an actor function η(s) with parameters θ_{π}, a critic function Q(s, a) with parameters θ_{Q}, and an experience buffer B as a set of tuples tᵢ=(sₜ, aₜ, r, sₜ₊₁) for each transition after action is conducted. The tuples are time independent.

DDPG alternates between running the policy to collect trajectories and updating the parameters. During the policy running stage, DDPG execute actions generated by current policy with noises added, e.g. a=π(s)+noise, and store the RL transitions into the experience buffer B. After sampled trajectories stored, during the training stage of off-policy model-free RL, a minibatch of consisting of N tuples are randomly sampled from the experience buffer B to update the actor and critic networks by minimizing the following loss:

$${L}_{Q} = \frac{1}{N} {\sum }_{i} {( {y}_{i} - {Q}_{∅} ( {s}_{i} , {π}_{θ} ( {s}_{i} ) ) )}^{2}$$

where target yᵢ is the expected future accumulated return from step i:

yᵢ=rᵢ+γQ_{Ø}(sᵢ₊₁,π_{θ}(sᵢ₊₁))

As is shown in this equation, the target term yᵢ also depends on the parameters Ø and θ. It potentially makes the training unstable. To solve this problem, the target network Q_{Øtarget} and π_{θtarget} are introduced. The target networks are initialized with the same parameters as Q_{Ø} and π_{θ}. During the training, Ø_{target} and θ_{target} are soft updated once per main network update by Polyak averaging:

Ø_{target}←τØ+(1−τ)Ø_{target}

θ_{target}←τθ+(1−τ)θ_{target}
Where τ<1.
Now the term yᵢ becomes:

yᵢ=rᵢ+γQ_{Ø}_{_{target}}(sᵢ₊₁,π_{θ}_{_{target}}(sᵢ₊₁))
For actor network, the goal is to learn a policy with parameter θ that solves:

Lₐ=max_{θ} [symbol] [Q_{Ø}(s,π_{θ}(S))], where [symbol] is the expectation value of its argument.

With a batch sampling of N transitions, the policy gradient could be calculated as:

$${∇}_{θ} {L}_{a} = \frac{1}{N} {\sum }_{i} {∇}_{a} {Q}_{∅} ( s , a ) {\vert}_{s = {s}_{i} , a = {π}_{θ} ( s )} {∇}_{θ} {π}_{θ} ( s ) {\vert}_{s = {s}_{i}} .$$

The off-policy reinforcement learning is more sample-efficient than on-policy reinforcement learning as it is able to repetitively optimize the policy from history trajectories. However, when the policy has bad initialization, it will lead to failed operations. In such case, RL needs to try and collect a huge amount of samples to approximate the correct Q function, and therefore, the sample-efficiency may still be an issue.

To further improve the model-free RL from a practical part, it is possible to first train the policy network with expert demonstrations. One reason caused the sample-efficiency issue is that at the beginning of the training stage, most of the generated trajectories are failed cases. The expert demonstrations may be stored into the experience buffer as well. During the training, besides the policy gradient loss, an auxiliary supervised learning loss may be computed too, as behaviour cloning (BC) loss:

L_{BC}=Σᵢ₌₁^{N}^{_{D}}∥π_{θ}(sᵢ)−a_{demo}_{ᵢ}∥₂, where a_{demo} is the demonstration action,N_{D} denotes the transitions that are sampled from human demonstration trajectories.

To prevent the policy from falling into the sub-optimal solution when learning from demonstrations, the q-filter may be applied: criticized by the critic network, the behaviour cloning loss only is applied when demonstration action has better performance. The final behaviour cloning loss may be formulated as

L_{BC}=Σᵢ₌₁^{N}_{D}∥π_{θ}(sᵢ)−aᵢ∥²1_{Q(s}_{ᵢ}_{,a}_{_{demoi}}_{)>Q(s}_{ᵢ}_{,π(s}_{ᵢ}₎₎

Respectively, the gradient applied to the policy network would be:

λ₁∇_{θ}Lₐ−λ₂∇_{θ}L_{BC}, wherein the λ₁ and λ₂ are hyper parameters that define the weight for each loss, λ₁+λ₂=1,λ₁>0,λ₂>0.

This kind of expert demonstration reduces the exploration phase of the RL.

The goal of the training stage of the RL model is to optimize the policy function to be able to accomplish the alignment task.

In this training example, the following parameters are given: 1) critic function Q with parameter Ø; 2) policy function IT with parameter θ; 3) target critic function Q_{target} with parameter Ø_{target}; 4) policy function π_{target} with parameter θ_{target}; 5) experience replay buffer B; 6) corner detection function F; 7) camera captured image set I=<im₁,im₂,im₃,im₄>. Multiple tryout trajectories may be required during the training stage:

At the beginning of the tryout trajectory, the spreader's position is randomized: The height distance between spreader and container is randomized between 1 to 3 meters. The x-y displacement dₓ and d_{y} are randomized between −25 cm to 25 cm. The angle displacement γ (skew) is randomized between −5 degrees to 5 degrees.

In training phase, for each step in the trajectory:
Detect corners: <p₁, p₂, p₃, p₄>=F(I)
Calculate image plane symmetric coordinates states sₜ=S_{IPS}_{ₜ}.
Sample actions aₜ using policy function it:

aₜ=π(sₜ)
Conduct action aₜ.

During the training, actions a may be e.g. determined based on event-based control or real-time based control. In event-based control, a indicates the displacements of x-y movements and rotation angles (e.g. a=[0.2, −0.2, 1] means: move the spreader to the right direction 20 cm, down 20 cm and rotate 1 degree clockwise). In real-time based control, a indicates the direction of x-y movements and rotation motion, and corresponding duration (e.g. a=[−10, 0, 20] means: move the spreader to left for 1 second and rotating the spreader clockwise for 2 seconds).
Wait for a certain time interval or till action a has accomplished and get next states sₜ₊₁=S_{IPS}_{ₜ₊₁}
Calculate the image symmetric based reward r.
Store the transition tuple t=<sₜ, aₜ, rₜ, sₜ₊₁> into experience buffer B.

At the end of each step:
Random sample mini-batch of experience of N transitions tᵢ=<sᵢ,aᵢ,rᵢ,sᵢ₊₁> from B.
Optimize Q by minimizing the loss:

$${L}_{Q} = \frac{1}{N} {\sum }_{i} {( ( {r}_{i} + γ {Q}_{{∅}_{target}} ( {s}_{i + 1} , {π}_{{θ}_{target}} ( {s}_{i + 1} ) ) ) - {Q}_{∅} ( {s}_{i} , {a}_{i} ) )}^{2}$$

Calculate the policy gradient

$${∇}_{θ} {L}_{a} = \frac{1}{N} {\sum }_{i} {∇}_{a} {Q}_{∅} ( s , a ) {\vert}_{s = {s}_{i} , a = {π}_{θ} ( s )} {∇}_{θ} {π}_{θ} ( s ) {\vert}_{s = {s}_{i}}$$

If transition tuple tᵢ is sampled from demonstrations, then update the actor policy with gradient:

λ₁∇_{θ}Lₐ−λ₂∇_{θ}L_{BC}
Else, just update the actor network by only one step gradient ascent using: ∇_{θ}Lₐ
At the end of each step, update the target networks' parameters using soft updating:

Ø_{target}←τØ+(1−ₜ)Ø_{target}

θ_{target}←τθ+(1−τ)θ_{target}

In testing phase, for each step in the trajectory:
Detect corners: <p₁, p₂, p₃, p₄>=F(I)
Calculate image-plane symmetric coordinates states S_{IPS}_{ₜ}.
Sample or evaluate actions a using policy function it:

a=π(S_{IPS}_{ₜ})
Conduct action a.
Actions a may be e.g. determined based on even-based control or real-time based control. In event-based control, a indicates the displacements of x-y movements and rotation angles (e.g. a=[0.2, −0.2, 1] means: move the spreader to the right direction 20 cm, down 20 cm and rotate 1 degree clockwise). In real-time based control, a indicates the direction of x-y movements and rotation motion, and corresponding duration (e.g. a=[−10, 0, 20] means: move the spreader to left for 1 second and rotating the spreader clockwise for 2 seconds).
Wait for a certain time interval or till action a has accomplished and get next states S_{IPS}_{ₜ₊₁}
Iterate this step.

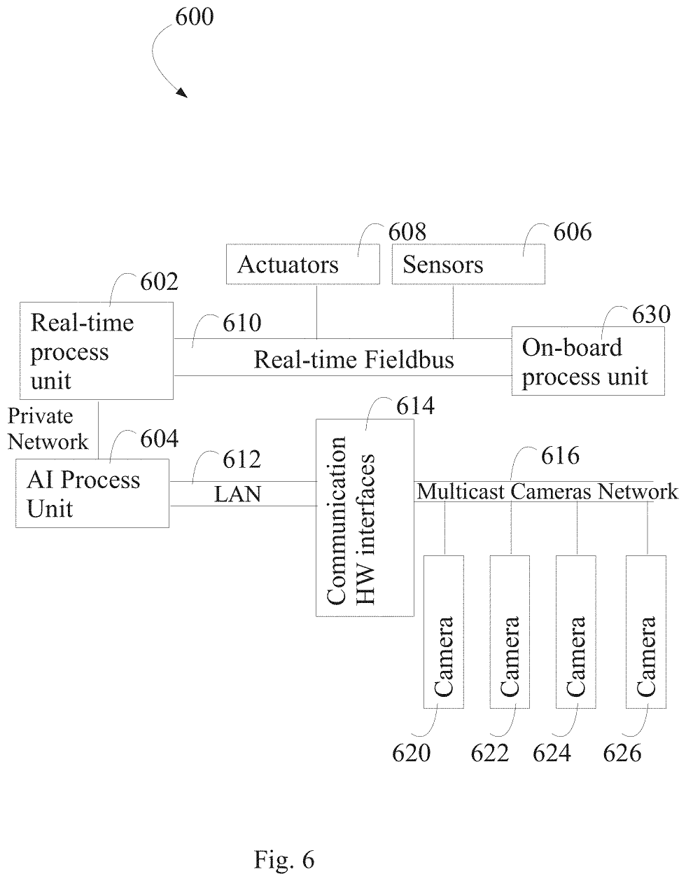

FIG. 6 shows, by way of example, a system architecture 600. The system architecture comprises a real-time process unit 602 and an artificial intelligence (AI) process unit 604. AI process unit can be a parallel processing capable processor which executes the RL and detects the features, e.g. container's corners. The role of the real-time processor 602 is to maintain real-time communication by receiving time-based signals and transmitting data for time-critical process demands. This process unit may be e.g. a reduced instruction set computer (RISC) process unit. The communication channel between the real-time hardware components, e.g. sensors 606 and actuators 608, and on-board process unit 630, may be e.g. a real-time fieldbus 610. Alternatively, a low-latency AI process unit 604 can comprise a real-time process unit 602 for receiving time-based signals and transmitting data for time-critical process demands. The sensors may comprise e.g. range sensors, distance sensors, lidars, etc.

The AI process unit 604 is the process unit that runs the RL algorithm. Running the RL algorithm does not necessarily need to be performed as a hard-real-time but as an online module which responds fast enough. AI process unit receives via a communication channel, e.g. a local area network 612 through communication interfaces 614 input from two or more cameras, e.g. from four cameras 620, 633, 624, 626 connected to multicast cameras network 616. The calculations are implemented on a process unit capable of providing fast response based on its on HW resources of memory, process power in CPU, or parallel processing power, e.g. in a graphics processing unit (GPU). Here, “fast enough” means that the RL results should be ready in the frequencies higher than the natural frequency of the crane mechanics. For example, the results should be ready, e.g. at least two to ten times higher than the natural frequency of the crane mechanics. Therefore, the specific process power specifications may depend on the requirements of the system mechanics and availability of the processors. Depending on the limitations of the application environment, the process units may be placed in the electric house of the mobile platform or the camera units. As shown in the FIG. 6, AI process unit 604 has access to platform's run-time information through the real-time process unit 602. AI process unit and real-time process unit may be physically placed in the same enclosure and/or partially share the resources.

FIG. 7 shows, by way of example, a block diagram of an apparatus 700 capable of performing the method disclosed herein. An apparatus configured to perform the method disclosed herein comprises means for performing the method. The means comprises at least one processor 710; and at least one memory 720 including computer program code, the at least one memory and the computer program code configured to, with the at least one processor, cause the performance of the apparatus. Memory 720 may comprise computer instructions that processor 710 is configured to execute. Memory 720 may be at least in part comprised in processor 710. Memory 720 may be at least in part external to apparatus 700 but accessible to apparatus 700.

The apparatus may be the AI process unit 604, or another apparatus connected to the AI process unit. The apparatus is capable of transmitting action commands, e.g. control action commands, directly or indirectly to the actuators 608 for moving the spreader according to the commands. The user interface, UT 730 may be e.g. the on-board process unit 630. The UI may comprise e.g. a display, a keyboard, a touchscreen, and/or a mouse. A user may operate the apparatus via the UI.

The apparatus may comprise communication means 740. The communication means may comprise e.g. transmitter and receiver configured to transmit and receive, respectively, information, via wired or wireless communication.

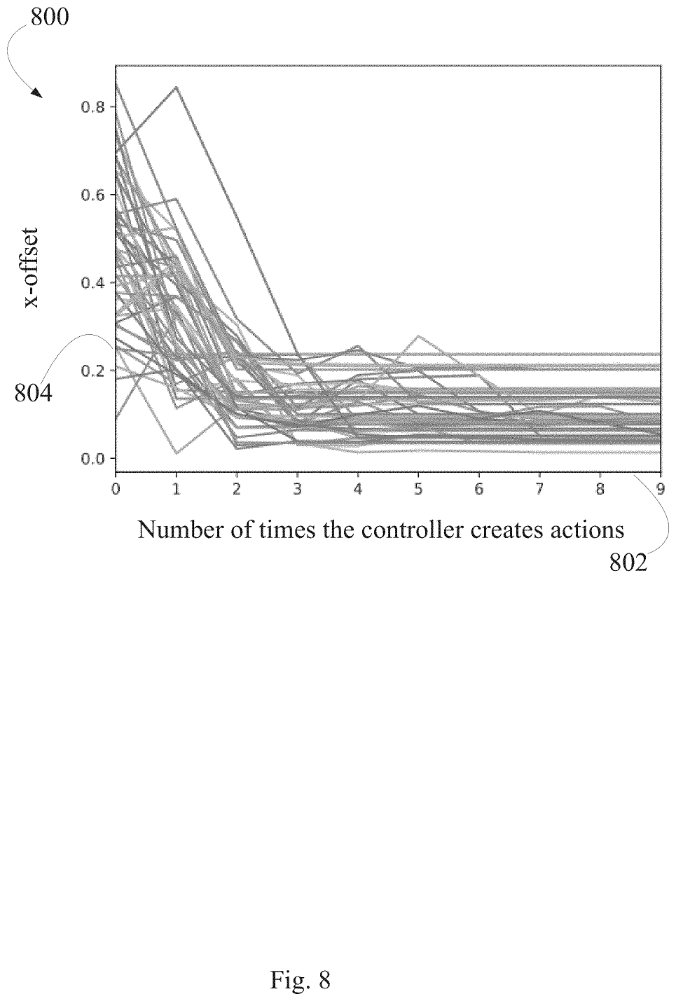

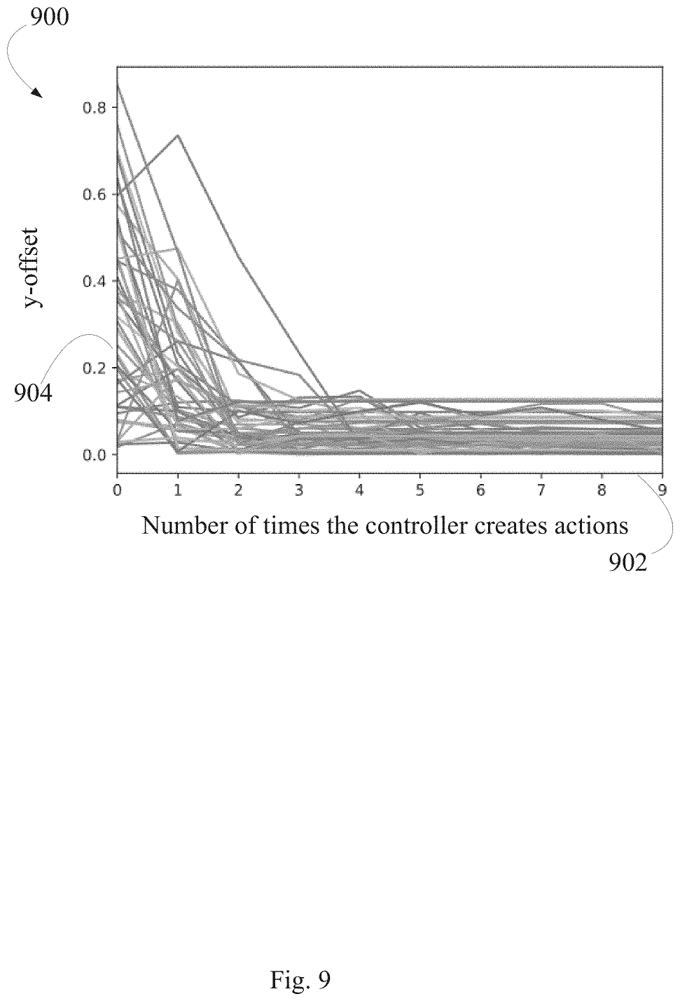

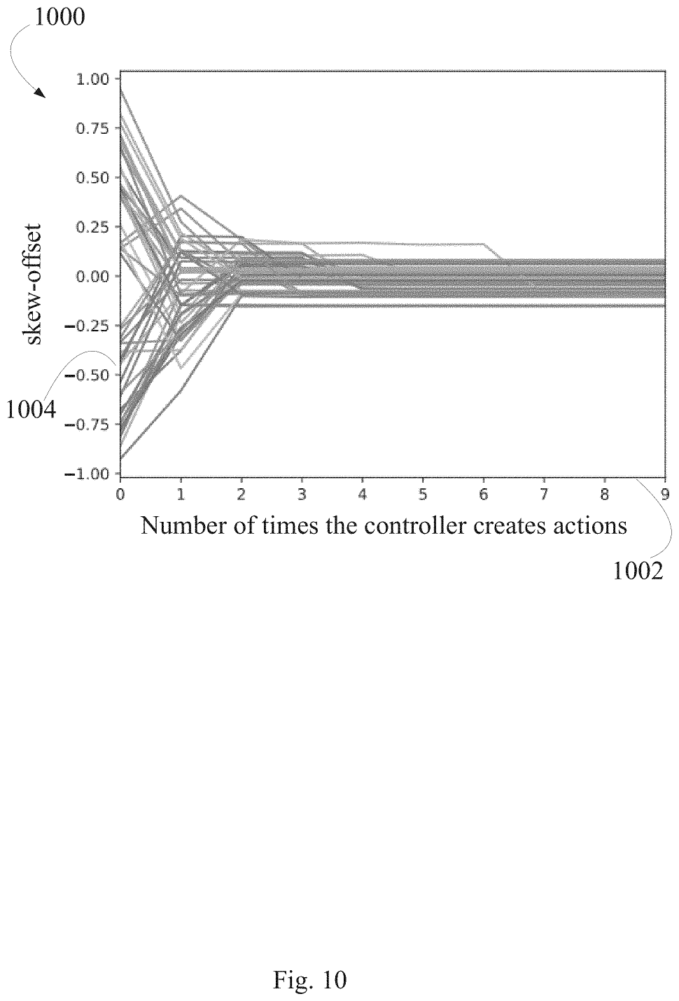

FIG. 8, FIG. 9 and FIG. 10 show, by way of examples, plots 800, 900, 1000 of error measurements of alignment trials. The x-axis 802, 902, 1002 of each of the plots represents the number of times the controller has created actions that cause the spreader to move. Different lines in the plots represent different alignment trials by the system or apparatus for positioning of a spreader.

The y-axis 804 of FIG. 8 represents the x-offset in normalized distance units. The x-offset indicates the difference in normalized distance units on the x-y plane, in x-direction, measured e.g. between center points of the spreader and the container. (See FIG. 1, offset 110)

The y-axis 904 of FIG. 9 represents the y-offset in normalized distance units. The y-offset indicates the difference in normalized distance units on the x-y plane, in y-direction, measured e.g. between center points of the spreader and the container. (See FIG. 1, offset 110)

The y-axis 1004 of FIG. 10 represents the skew-offset in normalized angular units. The skew-offset indicates the skew angle between the spreader and the container. (See FIG. 1, angle 130).

In spreader alignment phase, the goal of the policy generated by controller is to minimize the x-offset, y-offset and the skew angle such that they equal zero.

FIG. 8, FIG. 9 and FIG. 10 shows that the method disclosed herein enables positioning of the spreader with respect to a container accurately and within acceptable tolerances of the mechanical system. The error is reduced to approximately ¼ of the maximum offset in the examples of FIG. 8 and FIG. 9, and to approximately ⅓ of the maximum offset in the example of FIG. 10.

1. An apparatus comprising at least one processor; and at least one memory including computer program code, the at least one memory and the computer program code configured to, with the at least one processor, cause the apparatus to perform:
receiving a first image of a first feature of a load;
receiving a second image of a second feature of the load;
determining image plane coordinates of the features of the load based on the first image and the second image;
determining a pairwise operation between the image plane coordinates of the first feature and the image plane coordinates of the second feature, wherein a pairwise operator of the pairwise operation has a monotonic or piecewise monotonic behaviour;
determining one or more action candidates based on the pairwise operation;
evaluating the one or more action candidates using an intermediate medium embodying historical experience information within a finite time horizon to obtain cost(s) and/or reward(s) for the one or more action candidates; and
determining a control action based on the cost(s) and/or reward(s) of the action candidates, wherein the control action causes a spreader to move with respect to the load.

2. The apparatus of claim 1, wherein a self-exploring algorithm is used in evaluating the one or more action candidates.

3. The apparatus of claim 1, wherein the one or more action candidates are sample time independent.

4. The apparatus of claim 1, wherein the one or more action candidates and control action are defined based on displacement to x-direction, displacement to y-direction and rotation.

5. The apparatus of claim 1, wherein the pairwise operator has a piecewise monotonic behaviour correlated with decreasing or increasing errors in alignment of the spreader and the load; and
wherein the pairwise operation is a pairwise symmetry operation; or
the pairwise operator is a norm of dot or cross multiplication of error vectors in the first image and the second image; or
the pairwise operator is a norm of dot or cross multiplication of feature position vectors in the first image and the second image.

6. The apparatus of claim 1, wherein the reward achieves its highest value when the spreader substantially aligns with the load or achieves substantial alignment in the finite time horizon in the future.

7. The apparatus of claim 1, wherein the cost is proportional to force or energy or pressure or voltage or current or placement or placement consumption of the action candidates and their effect in the spreader motion at the current moment or in the finite time horizon in the future; and/or reflects risk of losing features in a camera's field of view at the current moment or in the finite time horizon in the future.

8. The apparatus of claim 1, further caused to perform:
transmitting the control action to one or more actuators for moving the spreader with respect to the load.

9. The apparatus of claim 1, wherein the first image is received from a first camera located on a first corner of a spreader and the second image is received from a second camera located on a second corner of the spreader, wherein the first corner and the second corner are different corners, and wherein the first feature of the load is a first corner of a container and the second feature of the load is a second corner of the container, wherein the first corner of the spreader and the first corner of the container are corresponding corners and the second corner of the spreader and the second corner of the container are corresponding corners.

10. The apparatus of claim 1, wherein the first image is received from a first camera located on a first corner of a spreader and the second image is received from a second camera located on a second corner of the spreader, wherein the first corner and the second corner are different corners, and wherein the first feature of the load is a first corner of a container and the second feature of the load is a second corner of the container, wherein the first corner of the spreader and the first corner of the container are corresponding corners and the second corner of the spreader and the second corner of the container are corresponding corners; wherein the apparatus is further caused to perform:
receiving a third image of a third feature of the load, wherein the third image is received from a third camera located on a third corner of the spreader;
receiving a fourth image of a fourth feature of the load, wherein the fourth image is received from a fourth camera located on the fourth corner of the spreader; wherein the third corner and the fourth corner are different corners than the first corner and the second corner; and wherein the third feature of the load is a third corner of the container and the fourth feature of the load is a fourth corner of the container, wherein the third corner of the spreader and the third corner of the container are corresponding corners and the fourth corner of the spreader and the fourth corner of the container are corresponding corners; and the apparatus further comprises means for determining image plane coordinates of the third and fourth features of the load based on the third image and the fourth image;
determining another pairwise operation between the image plane coordinates of the third feature and the image plane coordinates of the fourth feature, wherein the pairwise operator of the pairwise operation has a monotonic or piecewise monotonic behaviour; and
determining one or more action candidates based on the pairwise operations.

11. (canceled)

12. A method comprising:
receiving a first image of a first feature of a load;
receiving a second image of a second feature of the load;
determining image plane coordinates of the features of the load based on the first image and the second image;
determining a pairwise operation between the image plane coordinates of the first feature and the image plane coordinates of the second feature, wherein a pairwise operator of the pairwise operation has a monotonic or piecewise monotonic behaviour;
determining one or more action candidates based on the pairwise operation;
evaluating the one or more action candidates using an intermediate medium embodying historical experience information within a finite time horizon to obtain cost(s) and/or reward(s) for the one or more action candidates; and
determining a control action based on the cost(s) and/or reward(s) of the action candidates, wherein the control action causes a spreader to move with respect to the load.

13. The method of claim 12, wherein a self-exploring algorithm is used in the evaluating the one or more action candidates.

14. The method of claim 12, wherein the one or more action candidates are sample time independent.

15. The method of claim 12, wherein the one or more action candidates and control action are defined based on displacement to x-direction, displacement to y-direction and rotation.

16. The method of claim 12, wherein the pairwise operator has a piecewise monotonic behaviour correlated with decreasing or increasing errors in alignment of the spreader and the load; and
wherein the pairwise operation is a pairwise symmetry operation; or
the pairwise operator is a norm of dot or cross multiplication of error vectors in the first image and the second image; or
the pairwise operator is a norm of dot or cross multiplication of feature position vectors in the first image and the second image.

17. The method of claim 12, wherein the reward achieves its highest value when the spreader substantially aligns with the load or achieves substantial alignment in the finite time horizon in the future.

18. The method of claim 12, wherein the cost is proportional to force or energy or pressure or voltage or current or placement or placement consumption of the action candidates and their effect in the spreader motion at the current moment or in the finite time horizon in the future; and/or reflects risk of losing features in a camera's field of view at the current moment or in the finite time horizon in the future.

19. The method of claim 12, further comprising:
transmitting the control action directly or indirectly to one or more actuators for moving the spreader with respect to the load.

20. The method of claim 12, wherein the first image is received from a first camera located on a first corner of a spreader and the second image is received from a second camera located on a second corner of the spreader, wherein the first corner and the second corner are different corners, and wherein the first feature of the load is a first corner of a container and the second feature of the load is a second corner of the container, wherein the first corner of the spreader and the first corner of the container are corresponding corners and the second corner of the spreader and the second corner of the container are corresponding corners.

21. (canceled)

22. A non-transitory computer readable medium comprising program instructions that, when executed by at least one processor, cause an apparatus to perform at least:
receiving a first image of a first feature of a load;
receiving a second image of a second feature of the load;
determining image plane coordinates of the features of the load based on the first image and the second image;
determining a pairwise operation between the image plane coordinates of the first feature and the image plane coordinates of the second feature, wherein a pairwise operator of the pairwise operation has a monotonic or piecewise monotonic behaviour;
determining one or more action candidates based on the pairwise operation;
evaluating the one or more action candidates using an intermediate medium embodying historical experience information within a finite time horizon to obtain cost(s) and/or reward(s) for the one or more action candidates; and
determining a control action based on the cost(s) and/or reward(s) of the action candidates, wherein the control action causes a spreader to move with respect to the load.

23. (canceled)
